(19) United States
(12) Patent Application Publication
(10) Pub. No.: US 2025/0385947 A1
(43) Pub. Date: Dec. 18, 2025

(54) MULTIPROTOCOL WIRELESS INTERNET OF THINGS MODULE

(71) Applicant: Tyco Fire & Security GmbH, Neuhausen am Rheinfall (CH)

(72) Inventors: Swapnil Subhash Chavan, Pune (IN); Bhagyashree Jayant Tambolkar, Pune (IN); Robin Raju, Gurgaon (IN); Padmanabh Pandurang Gawai, Pune (IN)

(73) Assignee: Tyco Fire & Security GmbH, Neuhausen am Rheinfall (CH)

(21) Appl. No.: 18/902,754

(22) Filed: Sep. 30, 2024

(30) Foreign Application Priority Data
Jun. 12, 2024 (IN) 202441045201

(51) Int. Cl. H04L 67/12

(52) U.S. Cl. CPC H04L 67/12

(57) ABSTRACT

At least one embodiment relates to a building device. The building device includes a circuit board, a wireless circuit, and a microcontroller (MCU) module configured for various tasks. The device can include a sensor. The wireless circuit is configured to operate according to multiple protocols and transmit and receive wireless data. The MCU is coupled to the wireless circuit and is configured to control building equipment using the wireless data and sensor data from the sensor. The sensor, the MCU, and the wireless circuit can be provided in a single module.

### CROSS REFERENCE TO RELATED APPLICATIONS

This application claims the benefit of and the priority to Indian Provisional Patent Application No. 20/244,1045201 filed Jun. 12, 2024, the entire disclosure of which is incorporated by reference herein. The present disclosure is also related to U.S. application Ser. No. 18/123,964 filed Mar. 20, 2023, Hall et al. and assigned to the assignee of the present application and incorporated herein by reference in its entirety.

### BACKGROUND

A building can include various types of building subsystems and equipment, e.g., heating, ventilation, and/or air conditioning (HVAC) systems, security systems, fire response systems, etc. Communication between building systems and among equipment with each system can occur directly between systems and devices or via networks.

### SUMMARY

At least one embodiment relates to a building device. The building device includes a circuit board, a wireless controller, and a microcontroller (MCU) module configured for various tasks.

Some embodiments relate to a device including a sensor, a wireless circuit configured to operate according to multiple protocols (e.g., two or more or three or more) and transmit and receive wireless data, and a microcontroller (MCU) module. The MCU is coupled to the wireless circuit and is configured to control building equipment using the wireless data and sensor data from the sensor. The sensor, the MCU, and the wireless circuit are provided in a single module.

In some embodiments, the MCU and the wireless circuit are integrated together. In some embodiments, the single module collects and stores the sensor data and communicates with other nodes using a blockchain network. In some embodiments, the device includes a sensor interface for connecting to other sensors.

In some embodiments, single module is provided on a single circuit board. In some embodiments, the MCU and the wireless circuit are provided on opposite planar sides of the single circuit board. In some embodiments, the MCU and the wireless circuit are provided in a single integrated circuit package. In some embodiments, the device includes a universal serial bus interface.

Some embodiments relate to a device including a wireless circuit configured to operate according to multiple protocols and transmit and receive wireless data, and a microcontroller (MCU) module. The MCU is coupled to the wireless circuit and is configured to collect and store the wireless data locally and communicate the wireless data to other nodes on a blockchain network.

In some embodiments, the wireless data is provided as WiFi data or Bluetooth data based on environmental conditions. In some embodiments, the wireless circuit and the MCU are in a single module. In some embodiments, the MCU is configured to use the wireless data to optimize the performance of a heating, ventilating, or air conditioning system. In some embodiments, the wireless data is temperature data.

In some embodiments, the device also includes a sensor interface, and the MCU is configured to monitor sensor data for water leaks and temperature changes, and perform equipment performance scheduling.

Some embodiments relate to a device including a sensor, a wireless circuit configured to operate according to multiple protocols and transmit and receive wireless data. The device also includes a microcontroller (MCU) module. The MCU is coupled to the wireless circuit and is configured collect and store sensor data from the sensor locally and communicate the wireless data to other nodes using peer-to-peer encrypted communication.

In some embodiments, the sensor data is temperature data, humidity data, air quality data, or carbon dioxide data. In some embodiments, the MCU performs an authentication protocol for the peer-to-peer encrypted communication. In some embodiments, the sensor, the MCU and the wireless circuit are provided in a single module. In some embodiments, the MCU is configured to collect and store the wireless data locally and communicate the wireless data to the other nodes on a blockchain network. In some embodiments, the MCU is configured to control building equipment using the wireless data and the sensor data from the sensor, and the sensor, the MCU and the wireless circuit are provided in a single module.

Another embodiment relates to a system for monitoring and controlling a device of building equipment. The system includes a wireless circuit, a processor, and one or more memory devices having instructions stored thereon that, when executed by one or more processors, cause the one or more processors to perform operations.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a drawing of a building equipped with a building management system (BMS) and a HVAC system, according to some embodiments.

FIG. 2 is an illustration of a controller installed in a piece of building equipment of the building of FIG. 1, according to some embodiments.

FIG. 3 is a block diagram of a module including a microcontroller and wireless circuit for use in the BMS illustrated in FIG. 1 in accordance with some embodiments;

FIG. 4 is a block diagram of a module including a wireless/controller circuit for use in the BMS illustrated in FIG. 1 in accordance with some embodiments; and

FIG. 5 is a block diagram of a module including a wireless circuit and dongle for use in the BMS illustrated in FIG. 1 in accordance with some embodiments;

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a chiller is an apparatus that is used to generate temperature controlled water, most often cooled water, which can be used to cool air, products, machines, etc. Chillers may include a controller configured to control one or more digital, electrical, and/or signal processing functions, for example to implement one or more automated actions (e.g., communicate information, initiate or implement control decisions, provide one or more indicators or alerts, etc.). Controllers often include one or more circuits or circuit boards, for example a printed circuit board (e.g., PCB), and/or one or more microcontrollers or microcontroller units (e.g., MCUs). The PCBs and/or MCUs of controllers can include circuitry configured to implement the one or more digital, electrical, and/or signal processing functions of the controller. Further, PCBs and MCUs are often coupled (e.g., via wires, soldering, pins, pads, etc.) to facilitate the communication of signals or calls. However, the compatibility of different PCBs and MCUs is often dependent on the component configurations of the specific PCBs/MCUs to be implemented in the controller (e.g., pin-out diagrams, connection point configurations, input/output configurations, communications protocols, etc.).

As described herein, it is contemplated that the systems and methods described may be readily applied to various building equipment devices without departing from the teachings of the present disclosure. Building equipment devices may be a device of an HVAC system (e.g., heaters, chillers, heat pumps, air handling units, pumps, fans, thermal energy storage, etc., and/or any other device configured to provide heating, cooling, ventilation, or other services for a building), energy generation and/or storage devices (e.g., thermal storage tanks, battery banks, gas turbines, steam turbines, etc.), a device of a security system (e.g., occupancy sensors, video surveillance cameras, digital video recorders, video processing servers, intrusion detection devices, access control devices and servers, and/or other security-related devices), a device of a lighting system (e.g., light fixtures, ballasts, lighting sensors, dimmers, or other devices configured to controllably adjust the amount of light to a building, etc.), a device of a fire alerting system (e.g., fire detection devices, fire notification devices, fire suppression devices, etc.), and/or a device of any other system that is capable of managing building functions or devices, or any combination thereof.

As also described herein, it is contemplated that the input and/or output signals, calls and/or responses, control signals and/or control decisions described herein may be applied to various automate actions without departing from the teachings of the present disclosure. An automated action may include providing an indication to a device (e.g., a message or alert to a user device, a device of building equipment, a component of a BMS, etc.), for example indicating a characteristic of a device (e.g., operating characteristic, operating parameters, that a fault has been detected, and/or that maintenance should be initiated, etc.). The automated action may also include providing instructions to a device (e.g., instructions to adjust the operating conditions of the device, etc.), controlling one or more components of the (e.g., controlling the device to adjust the operating conditions of the device), controlling one or more components of a building management system, providing an indication to the user device (e.g., providing a GUI on a user interface, providing a message to the user device indicating the device is operating as expected, etc.), providing instructions to a storage system (e.g., instructions to store data and/or automated action data, etc.), and/or any other suitable action relating to the operation of the device and/or another system.

In some embodiments, a low cost internet of things (IOT) module is configured for multiple wireless protocols. The modules can be configured for use with or as part of HVAC equipment and can perform any of the operations described above in some embodiments. In some embodiments, the module is compact or small in size and supports multiple wireless protocols including but not limited to Bluetooth protocols, Wi-Fi protocols, and Zigbee protocols. In some embodiments, a small modular device uses the 2.4 GHz band for wireless communications (WiFi 6 standard) and includes a high speed universal serial port (USB). The module is provided on a 10 millimeter (mm) by 10 mm package in some embodiments. In some embodiments, the multiple wireless protocols include but are not limited to Bluetooth protocols, Wi-Fi protocols, Zigbee, near filed communication, and Matter protocols and combinations thereof.

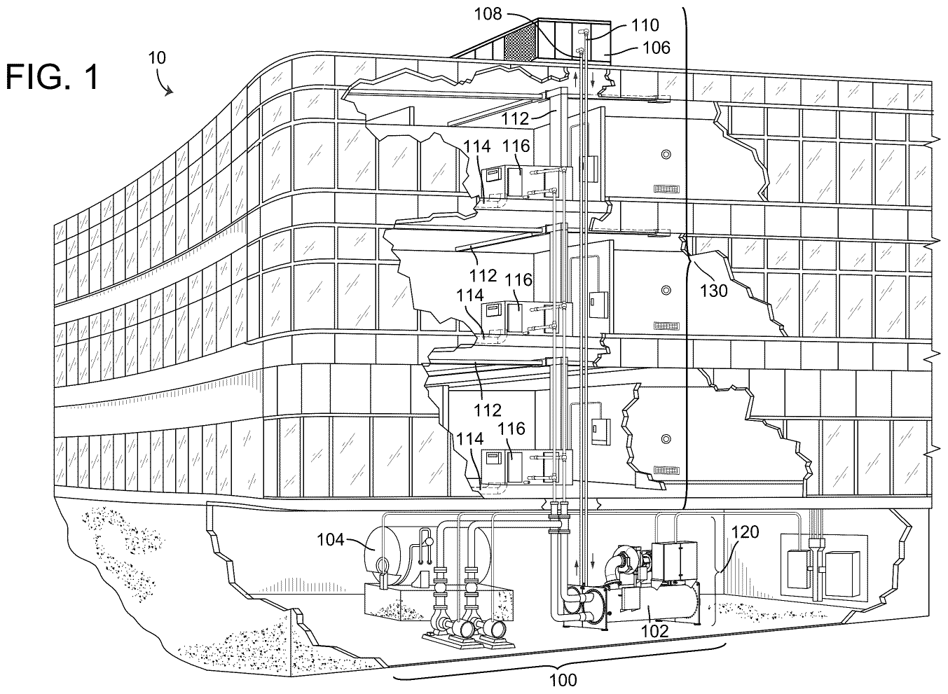

Referring now to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

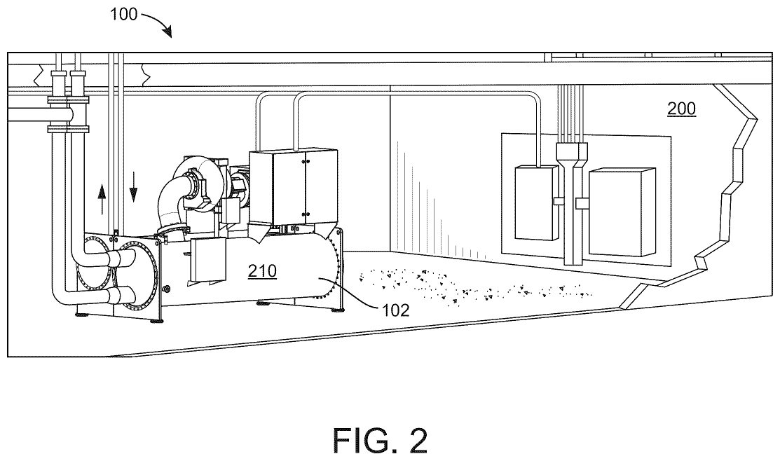

Referring now to FIG. 2, a cross-sectional illustration of a portion of the building 10 is shown, according to an exemplary embodiment. As shown in FIG. 2, the building 10 includes a room 200 having a piece of building equipment, shown as the chiller 102. As noted above, building equipment devices may be a device of an HVAC system, energy generation and/or storage system, a device of a lighting system, a device of a fire alerting system, and/or a device of any other system that is capable of managing building functions and/or devices, or any combination thereof. It should be understood that FIG. 2 shows an example configuration suitable for use with the systems and methods described herein.

As shown in FIG. 2, the chiller 102 includes a controller 210. The controller 210 may be communicably coupled with the chiller 102. In the example of FIG. 2, the controller 210 is located within the chiller 102. In some embodiments, the controller 210 is located within the room 200 and/or at another suitable location within or outside the building 10 (e.g., outside the chiller 102). According to an exemplary embodiment, the controller 210 is configured to facilitate the communication of information relating to the chiller 102 (e.g., setpoints, operating parameters, operating characteristics, operating boundaries, etc.), for example between one or more external systems and/or devices, as discussed below. In an exemplary embodiment, the controller 210 is also configured to communicate and/or generate one or more control decisions (e.g., control signals, operating signals, etc.) for the chiller 102, for example to control one or more components of the chiller 102 (e.g., an actuator, valve, pump, motor, condenser, heat exchanger, software, security key, etc.). The controller 210 may be configured specifically for installation in the chiller 102, for example by including specialty mounts or other couplings suited for use with the chiller 102. It should be understood that while the controller 210 is described herein as an example electronic device that may be installed in the chiller 102, many other electronic devices or components may be installed in the chiller 102, the room 200, and/or the building 10, and fall within the scope of the present disclosure (e.g., a microcontroller unit, a micro-computer unit, etc.). For example, a controller 210 can be a control circuit or other device for any type of building equipment including but not limited to actuators, valves, roof top units, air handling units, thermostats, temperature sensors, damper controllers, fire equipment, security equipment, cameras, etc.

Controller 210 can be associated with any type of building equipment, shown as the chiller 102, and is configured to facilitate the communication of information and/or generation of control decisions (e.g., signals) relating to the equipment in some embodiments. In some embodiments, controller 210 includes a printed circuit board (PCB), a microcontroller (MCU) module or microcontroller unit module, and a wireless unit The controller 210 may further include a case, housing, or package, for example, to house and/or protect the various components of the controller 210.

According to some embodiments, the controller 210 may include a circuit board substrate on which circuitry is mounted, printed, and/or installed (e.g., transistors, diodes, resistors, capacitors, etc.). According to an exemplary embodiment, the circuitry is operable to provide data processing and/or data storage for the controller 210 (e.g., to facilitate the communication of information relating to the chiller 102, to generate control decisions or signals for the chiller 102, other equipment, etc.). In some embodiments, the controller 210 includes a number of connectors (e.g., mounting components, pins, etc.), for example to facilitate coupling to one or more components of the controller 210. For example, the controller 210 may include a number of connection points (e.g., pins, etc.) and/or couplings, for example to communicate input/output signals to/from the circuitry. In an exemplary embodiment, each of the connection points (e.g., pins, mounts, pads, etc.) are associated with one or more digital, electrical, and/or signal processing functions of the controller 210. For example, a first connection point (e.g., pin, mount, pad, etc.) may be associated with a direct voltage current or power measurement (e.g., from the chiller 102, the controller 210, etc.), a second connection point (e.g., pin, mount, pad, etc.) may be associated with a serial wire debug or programing interface (e.g., of the chiller 102, the controller 210, etc.), a third connection point (e.g., pin, mount, pad, etc.) may be associated a backup power for a real time clock (e.g., of the controller 210 302, etc.), etc. In this regard, each of the plurality of connection points (e.g., each of the pins, mounts, pads, etc.) may be associated with a specific function, for example to communicate information and/or generate control decisions relating to a piece of building equipment (e.g., the chiller 102).

IOT Module with Multiprotocol Wireless Communication

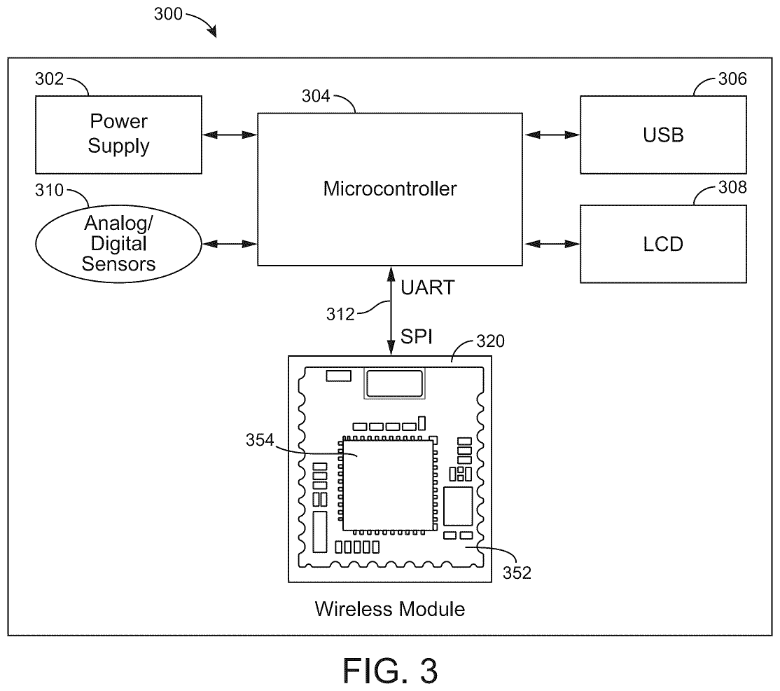

Referring now to FIG. 3, a module 300 that can be used as controller 210 (FIG. 2). Module 300 is configured as an IOT module with multiprotocol wireless communication capabilities in some embodiments. The capabilities can include Bluetooth (e.g., Bluetooth low energy (BLE), Wi-Fi, and Zigbee capabilities in some embodiments. In some embodiments, the capabilities include Bluetooth, Wi-Fi, Zigbee, near filed communication, and Matter protocols and combinations thereof. Module 300 is configured for an IOT application with MCU and wireless capabilities in some embodiments. Module 300 is configured to be used as a stand-alone controller for use with small, medium, and large platforms (e.g., manufactured by Johnson Controls International, plc) in some embodiments. Module 300 is also configured to be used as a stand-alone controller and gateway with wireless connectivity in some embodiments.

Module 300 includes a power supply 302, a MCU 304, a universal serial bus (USB) interface 306, a display 308 (e.g., liquid crystal display (LCD)), analog or digital sensors 310 (or interfaces therefor), and a wireless circuit 320. The LCD can be a color LCD. Module 300 is integrated with or interfaced with temperature, humidity, and/or carbon dioxide sensors in some embodiments.

Analog or digital sensors 310 can be any type of sensors. Analog or digital sensors 310 can be power sensors, current sensors, voltage sensors, temperature, humidity, and/or carbon dioxide sensors, air quality sensors, occupancy, particulate sensors, bio sensors, etc. Sensors 310 include a camera or camera interface in some embodiments.

Power supply 302 can be a battery or grid based supply (e.g., 120 VAC, 24 VDC, 24 VAC, etc.). USB interface 306 can be a serial interface. Firmware and power can be provided via interface 306.

MCU 304 is a JCI module cc-1352 in some embodiments. MCU 304 can operate at a 320 MHz processing speed in some embodiments. In some embodiments, module 300 includes MCU 304 and circuit 320 packaged together on an interposer or circuit board. In some embodiments, MCU 304 and supply 302 are integrated in a single integrated circuit. MCU 304 is coupled to circuit 320 via a serial peripheral interconnect (SPI) bus 312 in some embodiments.

In some embodiments, circuit 320 is a wireless module provided on a circuit board 352 including an integrated circuit package 354. Package 354 can be a BL616 or ESP32-s3 package in some embodiments. In some embodiments, circuit 320 is configured for three protocols (e.g., Wi-Fi, Zigbee, and BLE). Circuit 320 can be a Sipeed MOS IOT module or ESP32 module in some embodiments.

It should be understood that while the MCU 304 is configured to couple with the chiller 102, MCU 304 can be provided with one or more building management systems (e.g., a BMS) networks, and a storage systems. MCU 304 is configured to communicate, process, and analyze data (e.g., device data, MCU data, etc.) to generate and/or provide an interface that is configured to correlate (e.g., route) one or more input/output signals. MCU 304 may communicate with user devices, other modules, and networks (e.g., wirelessly via circuit 320 or via USB interface 306).

The user device may include one or more human-machine interfaces or client interfaces, (e.g., a graphical user interface, reporting interface, text-based computer interface, client-facing web service, web servers that provide pages to a web client, etc.) for controlling, viewing, and/or otherwise interacting with the MCU 304. The user device may be a mobile device or a stationary terminal. For example, the user device may be a smartphone, a tablet, a PDA, a laptop computer, a desktop computer, a computer workstation, a client terminal, a computer server with an interface, a remote or local interface, and/or any other type of mobile or non-mobile user interface device.

In some embodiments, the MCU 304 is configured to communicate with the chiller 102. Like the user device, the chiller 102 may include one or more human-machine interfaces or client interfaces, for controlling, viewing, and/or otherwise interacting with the chiller 102. In some embodiments, the chiller 102 is another device of an HVAC system (e.g., a heater, air handling unit, pumps, fans, thermal energy storage, etc., and/or another device configured to provide heating, cooling, ventilation, or other services for a building). In other embodiments, the chiller 102 is a device of an energy generation and/or storage system, a security system, a lighting system, a fire alerting system, and/or a device of any other system capable of managing building functions or devices, or any combination thereof. In yet other embodiments, the chiller 102 is an internet of things (IOT) device capable of communicating with the MCU 304.

In some embodiments, the MCU 304 is also configured to communicate with storage, the chiller 102, etc. The storage system may include one or more devices (e.g., RAM, ROM, Flash memory, hard disk storage, etc.) for storing data and/or computer code for completing and/or facilitating various processes, layers, and modules described herein. The storage system may be or include volatile memory or non-volatile memory, and may include database components, object code components, script components, and/or any other type of information structure for supporting the various activities and information structures described herein.

MCU 304 may be a general purpose or specific purpose processor, an application specific integrated circuit (ASIC), one or more field programmable gate arrays (FPGAs), a group of processing components, or other suitable processing components. The MCU 304 may further be configured to execute computer code or instructions stored in the memory or received from other computer readable media (e.g., CDROM, network storage, a remote server, etc.).

The memory may include one or more devices (e.g., memory units, memory devices, storage devices, etc.) for storing data and/or computer code for completing and/or facilitating the various processes described in the present disclosure. The memory may include random access memory (RAM), read-only memory (ROM), hard drive storage, temporary storage, non-volatile memory, flash memory, optical memory, or any other suitable memory for storing software objects and/or computer instructions. In some embodiments, the memory includes database components, object code components, script components, and/or any other type of information structure for supporting the various activities and information structures described in the present disclosure. The memory may be communicably connected to the processor, and may include computer code for executing (e.g., by the processor) one or more processes described herein. When the processor executes instructions stored in the memory, the processor may generally configure a circuit to complete such activities.

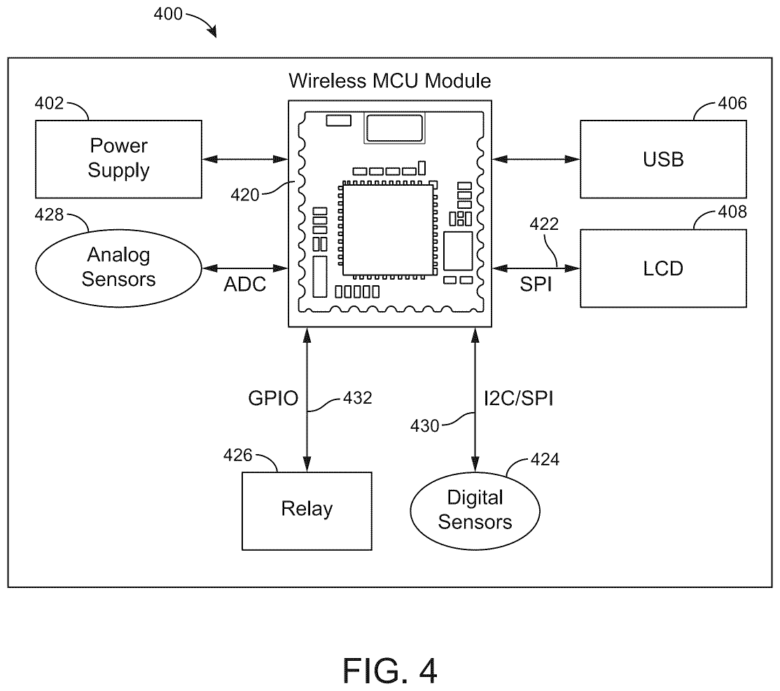

With reference to FIG. 4, module 400 is similar to module 300. Module 400 can be configured as a stand-alone controller for an IoT application. Module 400 includes a power supply 402 similar to power supply 402, a universal serial bus (USB) interface 406 similar to interface 306, a display 408 similar to display, analog sensors 410 (or interfaces therefor), digital sensors 424 (or interfaces therefor), a relay 426 and a combination MCU and wireless circuit 420 similar to wireless circuit 320 and MCU 304.

Analog sensors 428 are coupled to circuit 420 via an analog bus that may include an analog to digital converter. Digital sensors 424 are coupled to circuit 420 by an I2C or serial peripheral interface (SPI) bus in some embodiments. Display 408 is coupled to circuit 420 by an SPI bus. Relay 426 is coupled to circuit 420 by a general purpose input/output bus 432.

Relay 426 can be any device for providing a connection under control of circuit 420. Relay 426 can be a solid state relay or an electromagnetic relay in some embodiments.

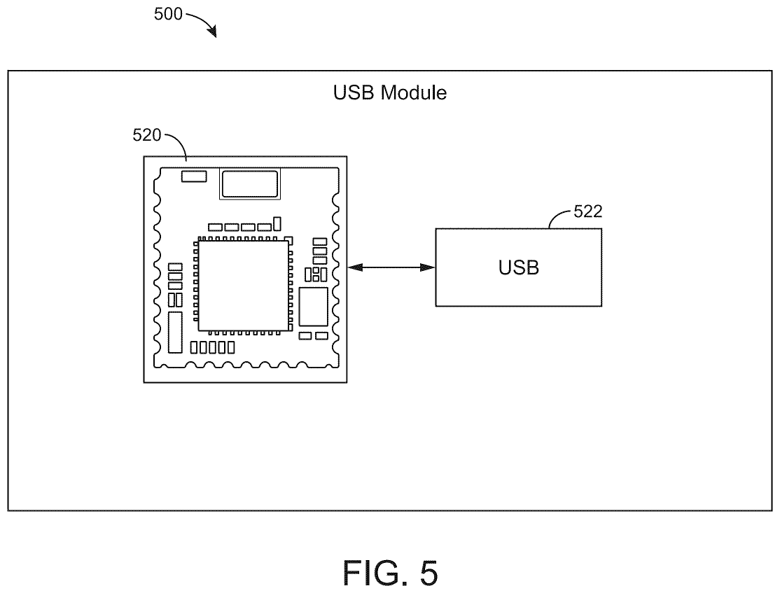

With reference to FIG. 5, module 500 is similar to module 300. Module 500 can be configured as a stand-alone controller and used with a USB interface 522, such as a USB dongle in some embodiments. Module 500 includes a combination MCU and wireless circuit 520 similar to wireless circuit 320 and MCU 304.

Modules 300, 400 and 500 can be configured for use as nodes in a decentralized sensor network with blockchain integration. For example, modules 300, 400 and 500 can incorporate a BL616 (RV32GCP) or similar chipset for low power consumption and multi-protocol capabilities in a building decentralized sensor network. Each sensor node or module 300, 400 and 500 can collect and store data locally on its flash memory and Wi-Fi and Bluetooth communications can be used to communicate with other nodes and upload data to a secure blockchain network. In some embodiments, modules 300, 400, and 500 can be configured to securely records transactions across multiple nodes in a building network. Modules 300, 400, and 500 can operate on a system of blocks, each containing a set of transactions, which are linked together in chronological order, forming a chain. Each block is cryptographically linked to the previous one, ensuring immutability and transparency of the recorded data.

Modules 300, 400, and 500 can be used in various applications, such as environmental monitoring, supply chain tracking, and asset management. In some embodiments, modules 300, 400, and 500 execute hashing algorithm to generate unique fixed-size outputs (hashes) for any input data for secure links between blocks in the chain and to secure transaction data. In some embodiments, modules 300, 400, and 500 execute consensus algorithms to achieve agreement among network participants on the validity of transactions and the state of the blockchain. Consensus algorithms can include Proof of Work (PoW), Proof of Stake (PoS), Delegated Proof of Stake (DPoS), and Practical Byzantine Fault Tolerance (PBFT). In some embodiments, modules 300, 400, and 500 execute digital Signature algorithms to verify the authenticity and integrity of transactions. Digital signature algorithms can include RSA (Rivest-Shamir-Adleman), ECDSA (Elliptic Curve Digital Signature Algorithm), and EdDSA (Edwards-curve Digital Signature Algorithm). In some embodiments, modules 300, 400, and 500 execute encryption algorithm and Merkle trees.

Modules 300, 400 and 500 can be configured for use as interactive smart home/building hubs with multiprotocol communication. For example, modules 300, 400 and 500 can incorporate a BL616 (RV32GCP) or similar chipset for multi-protocol communication that allows communication with various smart home devices using Wi-Fi and Bluetooth. Modules 300, 400 and 500 are configured to act as a central hub for controlling lights, thermostats, security systems, and other appliances. The RISC-V architecture can be used for custom software development to create unique user interfaces and automation rules. For example, the software could be used to create a more personalized and convenient smart home experience.

Modules 300, 400 and 500 can be configured for use in a decentralized data marketplace for IoT devices in some embodiments. The BL616 or similar chipset can be used to create a secure and efficient platform for IoT devices to share and exchange data. The RISC-V architecture can be used for secure data encryption and authentication protocols. For example, modules 300, 400, and 500 can incorporate a BL616 (RV32GCP) or similar chipset for peer-to-peer communication between devices, eliminating the need for a central server. Modules 300, 400 and 500 can could be used to create a new data economy where IoT devices can monetize their data and users can access valuable data insights.

Modules 300, 400 and 500 can be configured for use in an HVAC system optimization technique. BL616 or similar chipset sensors can be used to monitor temperature, humidity, and CO2 levels in different rooms or zones. The collected data can be used to optimize the performance of the HVAC system, leading to energy savings and improved comfort. BL616/similar chipset sensors can also communicate with smart thermostats and HVAC controllers for automated adjustments. Optimization can be model based optimization such as described in U.S. Patent Publication Nos. 20150316903 and 20150316903, incorporated herein by reference in their entireties. Multiprotocol capabilities allow for efficient, redundant communication in some embodiments. Protocols can be chosen to obtain the best signal quality and throughout in the environments given traffic on channels, interference, physical barriers, etc.

Modules 300, 400 and 500 can be configured for use in a building maintenance and management system. BL616 or similar chipset sensors can be used to monitor various parameters like water leaks, temperature changes, and equipment performance scheduling in some embodiments. This data can be used for predictive maintenance, identifying potential issues before they escalate into major problems scheduling in some embodiments. The BL616 or similar chipset can also be integrated with building management systems for automated alerts and maintenance scheduling in some embodiments.

Modules 300, 400 and 500 can be configured for use in sustainable building design. BL616 or similar chipset can achieve low power consumption and efficient data processing capabilities contribute to building sustainability. By optimizing energy usage and reducing maintenance requirements, BL616 or similar chipset-based systems can significantly improve the building's environmental impact

Modules 300, 400 and 500 can have the following exemplary capabilities: Tri-Mode Wireless: WiFi6/BT 5.2/Zigbee; High Frequency Operation: 320 MHz default; Ultra-low Power Consumption: Wifi6 low power; DSP Acceleration Support RISC-V; High speed USB: Support USB2.0 HS OTG, up to 480Mbps; Peripheral ports: RGB LCD, DVP Camera, SDIO; and small size: Place ceramic antenna on 10×11 mm or 18 mm×25.5 mm area. Modules 300, 400, and 500 can include SRAM memory of 400-600 KB, Flash memory of 4 MB, Bluetooth BT5.2 or BT 5, USB 2.0 HS or FS.

### Configuration of Exemplary Embodiments

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the MCU of the exemplary embodiment described in at least FIGS. 6-7 may be incorporated in the chiller of the exemplary embodiment described in at least FIGS. 1-3. Although only one example of an element from one embodiment that can be incorporated or utilized in another embodiment has been described above, it should be appreciated that other elements of the various embodiments may be incorporated or utilized with any of the other embodiments disclosed herein.

What is claimed:

1. A device, comprising:
a sensor;
a wireless circuit configured to operate according to multiple protocols and transmit and receive wireless data; and
a microcontroller (MCU) module coupled to the wireless circuit, the MCU being configured to control building equipment using the wireless data and sensor data from the sensor, wherein the sensor, the MCU and the wireless circuit are provided in a single module.

2. The device of claim 1, wherein the MCU and the wireless circuit are integrated together.

3. The device of claim 2, wherein the single module collects and stores the sensor data and communicates with other nodes using a blockchain network.

4. The device of claim 3, further comprising a sensor interface for connecting to other sensors.

5. The device of claim 1, wherein the single module is provided on a single circuit board.

6. The device of claim 5, wherein the MCU and the wireless circuit are provided on opposite planar sides of the single circuit board.

7. The device of claim 1, wherein the MCU and the wireless circuit are provided in a single integrated circuit package.

8. The device of claim 1, further comprising a universal serial bus interface.

9. A device, comprising:
a wireless circuit configured to operate according to multiple protocols and transmit and receive wireless data; and
a microcontroller (MCU) module coupled to the wireless circuit, the MCU being configured to collect and store the wireless data locally and communicate the wireless data to other nodes on a blockchain network.

10. The device of claim 9, wherein the wireless data is provided as WiFi data or Bluetooth data based on environmental conditions.

11. The device of claim 9, wherein the wireless circuit and the MCU are in a single module.

12. The device of claim 9, wherein the MCU is configured to use the wireless data to optimize the performance of a heating, ventilating, or air conditioning system.

13. The device of claim 12, wherein the wireless data is temperature data.

14. The device of claim 12, further comprising a sensor interface, and the MCU is configured to monitor sensor data for water leaks and temperature changes, and perform equipment performance scheduling.

15. A device, comprising:
a sensor
a wireless circuit configured to operate according to multiple protocols and transmit and receive wireless data, the multiple protocols comprising Wi-Fi, Bluetooth, or Zigbee protocols; and
a microcontroller (MCU) module coupled to the wireless circuit, the MCU being configured collect and store sensor data from the sensor locally and communicate the wireless data to other nodes using peer-to-peer encrypted communication.

16. The device of claim 15, wherein the sensor data is temperature data, humidity data, air quality data, or carbon dioxide data.

17. The device of claim 15, wherein the MCU performs an authentication protocol for the peer-to-peer encrypted communication.

18. The device of claim 15, wherein the sensor, the MCU and the wireless circuit are provided in a single module.

19. The device of claim 15, wherein the MCU is configured to collect and store the wireless data locally and communicate the wireless data to the other nodes on a blockchain network.

20. The device of claim 15, wherein the MCU is configured to control building equipment using the wireless data and the sensor data from the sensor, wherein the sensor, the MCU and the wireless circuit are provided in a single module.

21. The device of claim 15, wherein the multiple protocols comprise matter and near field communications protocols.

22. The device of claim 15, wherein the multiple protocols comprise Wi-Fi, Bluetooth, Zigbee, Matter and near field communications protocols.
